(19) United States
(12) Patent Application Publication
(10) Pub. No.: US 2026/0064618 A1
(43) Pub. Date: Mar. 5, 2026

(54) DATA COMMUNICATION DEVICE

(71) Applicant: Murata Manufacturing Co., Ltd., Nagaokakyo-shi (JP)

(72) Inventor: Kazuhiro NAKAMUTA, Nagaokakyo-shi (JP)

(21) Appl. No.: 19/377,655

(22) Filed: Nov. 3, 2025

Related U.S. Application Data
(63) Continuation of application No. PCT/JP2024/014239, filed on Apr. 8, 2024.

(30) Foreign Application Priority Data
May 12, 2023 (JP) 2023-079651

(51) Int. Cl. G06F 13/40; G06F 9/48

(52) U.S. Cl. CPC G06F 13/4063; G06F 9/4812

(57) ABSTRACT

A data communication device that enables a reduction in the circuit size is provided. A data communication device includes: a command interpretation device that is connected to a main device, receives, from the main device, a main signal including a command signal, an address signal that designates an address of at least one register included in a sub-device and a sub-device, and a write data signal to be stored in the register corresponding to the address, and interprets the command signal; and the sub-device and the sub-device that are connected to the command interpretation device via a first signal line through which a clock signal is transmitted and a second signal line through which a data signal is transmitted.

### CROSS REFERENCE TO RELATED APPLICATION

This is a continuation of International Application No. PCT/JP2024/014239 filed on Apr. 8, 2024 which claims priority from Japanese Patent Application No. 2023-079651 filed on May 12, 2023. The contents of these applications are incorporated herein by reference in their entireties.

### BACKGROUND OF THE DISCLOSURE

### Field of the Disclosure

The present disclosure relates to data communication devices.

### Description of the Related Art

In semiconductor devices, data are sometimes transmitted and received using serial communication between multiple devices. In serial communication, a main device (master device) and a sub-device (slave device) that is connected to the main device are used as devices. For example, transmitting a signal from the main device to the sub-device results in writing data to the sub-device. The sub-device may interpret a command included in the signal from the main device and perform an operation that corresponds to the command.

The circuit size of a circuit for command interpretation is large. Thus, in the case where each sub-device includes the circuit for command interpretation, the overall circuit size also becomes large. Furthermore, as a configuration in which each sub-device does not include the circuit for command interpretation, U.S. Patent Application Publication No. 2017/0192918 Specification describes a configuration in which an interface circuit that interprets a signal from the main device is provided in addition to the sub-devices.

### BRIEF SUMMARY OF THE DISCLOSURE

In the configuration described in U.S. Patent Application Publication No. 2017/0192918 Specification, the interface circuit is connected to the sub-devices that serve as destinations of data transmission via a clock bus, a data bus, and an enable bus through which an enable signal is transmitted. In the configuration described in U.S. Patent Application Publication No. 2017/0192918 Specification, the interface circuit selects one of the sub-devices using the enable bus and transmits data thereto. In this case, the enable bus is provided for each of the sub-devices, and this increases the overall circuit size.

The present disclosure is made in view of such circumstances, and a possible benefit thereof is to provide a data communication device that enables a reduction in the circuit size.

A data communication device according to one aspect of the present disclosure includes: a command interpretation device that is connected to a main device, receives, from the main device, a main signal including a command signal, an address signal that designates an address of at least one register included in at least one sub-device, and a write data signal to be stored in the register corresponding to the address, and interprets the command signal; and at least one sub-device connected to the command interpretation device via a first signal line through which a clock signal is transmitted and a second signal line through which a data signal is transmitted.

In the data communication device, the command interpretation device generates a write instruction signal in a case where information based on the data signal is written to one of the at least one sub-device on a basis of an interpretation result of the command, generates the data signal that is based on the address signal and the write data signal and is to be supplied to each of the at least one sub-device on the basis of the interpretation result of the command, and supplies, to each of the at least one sub-device, the write instruction signal via the first signal line or the second signal line and the data signal via the second signal line, and each of the at least one sub-device determines whether the register corresponding to the address specified by the address signal is included in the at least one sub-device or not, and writes the write data signal to the register in the case where the register is included in the at least one sub-device and the write instruction signal is supplied from the command interpretation device.

According to the present disclosure, it becomes possible to provide a data communication device that enables a reduction in the circuit size.

### BRIEF DESCRIPTION OF THE SEVERAL VIEWS OF THE DRAWINGS

FIG. 1 is a diagram illustrating one example of a circuit that includes a data communication device according to a present embodiment.

FIG. 2 is a diagram illustrating a configuration of a command interpretation device of the data communication device according to the present embodiment.

FIG. 3 is a diagram illustrating a configuration of a sub-device of the data communication device according to the present embodiment.

FIG. 4 illustrates examples of a main signal and a data signal according to the present embodiment.

FIG. 5 illustrates other examples of the main signal and the data signal according to the present embodiment.

FIG. 6 illustrates other examples of the main signal and the data signal according to the present embodiment.

FIG. 7 illustrates other examples of the main signal and the data signal according to the present embodiment.

FIG. 8 illustrates other examples of the main signal and the data signal according to the present embodiment.

FIG. 9 is a diagram illustrating another example of the configuration of the sub-device of the data communication device according to the present embodiment.

FIG. 10 is a diagram illustrating another example of the configuration of the sub-device of the data communication device according to the present embodiment.

### DETAILED DESCRIPTION OF THE DISCLOSURE

Hereinafter, an embodiment of the present disclosure will be described in detail while referring to the drawings. Note that the same reference characters are attached to the same constituent elements, and overlapping descriptions are omitted as much as possible.

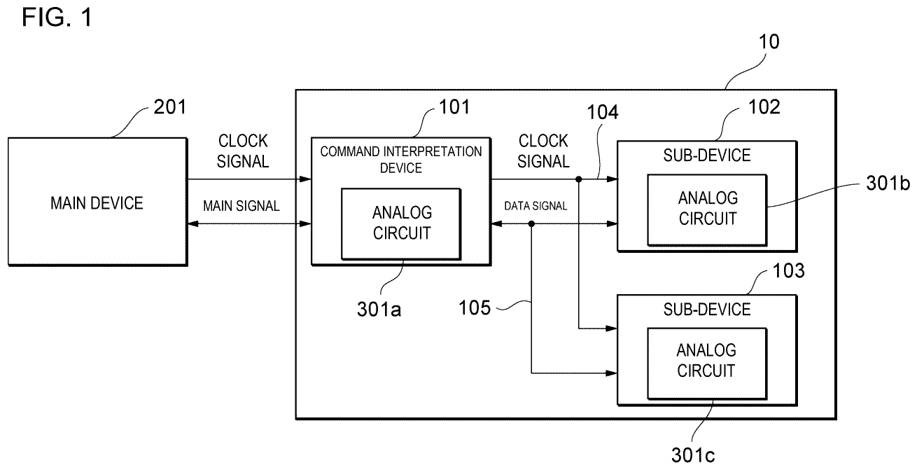

FIG. 1 illustrates one example of circuitry including a data communication device 10 according to the present embodiment, a main device 201, and analog circuits 301a, 301b, and 301c.

The data communication device 10 is a sub-device whose data communication is controlled by the main device 201.

The data communication device 10 includes a command interpretation device 101 and sub-devices 102 and 103. Note that in the example of FIG. 1, two sub-devices are exemplified as the sub-devices. However, the number of sub-devices may be greater than two or equal to one.

The command interpretation device 101 is connected to each of the sub-devices 102 and 103 via two wiring lines, a clock signal line 104 and a data signal line 105. The command interpretation device 101 and the sub-devices 102 and 103 conduct bidirectional communication by transmitting and receiving data using a two-wire bus. Note that the data communication device 10 may conform with an I2C system or any other communication system.

The main device 201 transmits a main signal to the command interpretation device 101 to rewrite information stored in a register or registers of the sub-devices 102 and 103. The main signal includes a command signal, an address signal designating an address of at least one register included in at least one sub-device, and a write data signal to be stored in the register corresponding to the address. Furthermore, the main device 201 transmits a clock signal to the command interpretation device 101.

The command signal represents information that specifies the kind of writing based on the main signal. The command signal represents information that specifies a writing format and the like such as, for example, a format for performing writing to at least one register in a certain device, a format for performing writing to one register in a certain device, a format for performing writing to one register in a certain device while masking a bit value or bit values, or any other similar format. The address signal represents information that identifies each of registers of the sub-devices 102 and 103. For example, the address signal represents 5-bit data or 8-bit data. The write data signal represents data to be written on a register, and the number of bits is, for example, 8 bits.

The analog circuit 301a is connected to a register of the command interpretation device 101 and performs a control operation such as, for example, a bias control operation or the like on the basis of information stored in the register of the command interpretation device 101. Furthermore, the analog circuits 301b and 301c are connected to registers of the sub-devices 102 and 103, respectively, and perform control operations such as, for example, bias control operations and the like on the basis of information stored in the registers of the sub-devices 102 and 103. In the present embodiment, the command interpretation device 101 and the sub-devices 102 and 103 are described as different devices. However, all of the command interpretation device 101 and the sub-devices 102 and 103 share a common function of controlling an analog circuit on the basis of the information stored in their registers.

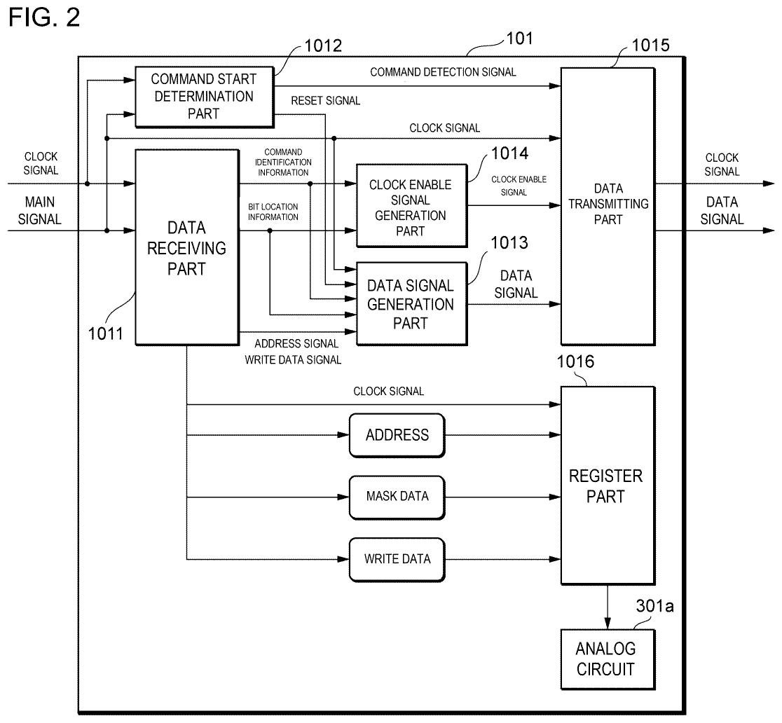

Each part of the command interpretation device 101 is described with reference to FIG. 2. The command interpretation device 101 includes a data receiving part 1011, a command start determination part 1012, a data signal generation part 1013, a clock enable signal generation part 1014, a data transmitting part 1015, and a register part 1016.

The data receiving part 1011 receives a clock signal and a main signal from the main device 201 and performs an operation of interpreting the main signal. For example, the data receiving part 1011 generates command identification information for identification of a command on the basis of information specified by the command signal included in the main signal. The data receiving part 1011 transmits the command identification information to the data signal generation part 1013 and the clock enable signal generation part 1014, which will be described below.

The data receiving part 1011 transmits the address signal and the write data signal, which are included in the main signal, to the data signal generation part 1013. Furthermore, the data receiving part 1011 generates bit location information that specifies a location at which the command identification information is added and transmits the bit location information to the data signal generation part 1013 and the clock enable signal generation part 1014. Note that the bit location information may include, in addition to the information of the location where the command identification information is added, information that specifies a start location and an end location of a signal in the data signal, such as the start location of the address signal, the start location of the write data signal, and the like.

The command start determination part 1012 determines whether a transmission of the command signal from the main device 201 to the command interpretation device 101 is started or not, on the basis of the clock signal and the main signal. When the supply of the command signal starts, the command start determination part 1012 transmits a command detection signal to the data transmitting part 1015. Furthermore, the command start determination part 1012 transmits a reset signal to the data signal generation part 1013.

The data signal generation part 1013 generates a data signal to be transmitted to the sub-devices 102 and 103 on the basis of the command identification information, the bit location information, the address signal, and the write data signal from the data receiving part 1011. The data signal generation part 1013 transmits the data signal to the data transmitting part 1015.

The clock enable signal generation part 1014 generates a clock enable signal on the basis of the command identification information and the bit location information. The clock enable signal is a signal for starting a transmission of the data signal from the command interpretation device 101 to the sub-device 102. In the case where the timing determined on the basis of the bit location information specifies a time point at which the transmission of the data signal to the sub-devices 102 and 103 starts, the clock enable signal generation part 1014 generates a clock enable signal and transmits the clock enable signal to the data transmitting part 1015.

When the data transmitting part 1015 receives the command detection signal and is supplied with the clock enable signal from the clock enable signal generation part 1014, the data transmitting part 1015 transmits, to the sub-devices 102 and 103, the data signal received from the data signal generation part 1013 and the clock signal supplied to the data transmitting part 1015. The data transmitting part 1015 transmits the clock signal through the clock signal line 104 and transmits the data signal through the data signal line 105.

The register part 1016 is a rewritable storage area including a register or registers. Furthermore, the register part 1016 controls the writing to each register on the basis of signals from the data receiving part 1011. The register part 1016 is connected to the analog circuit 301a.

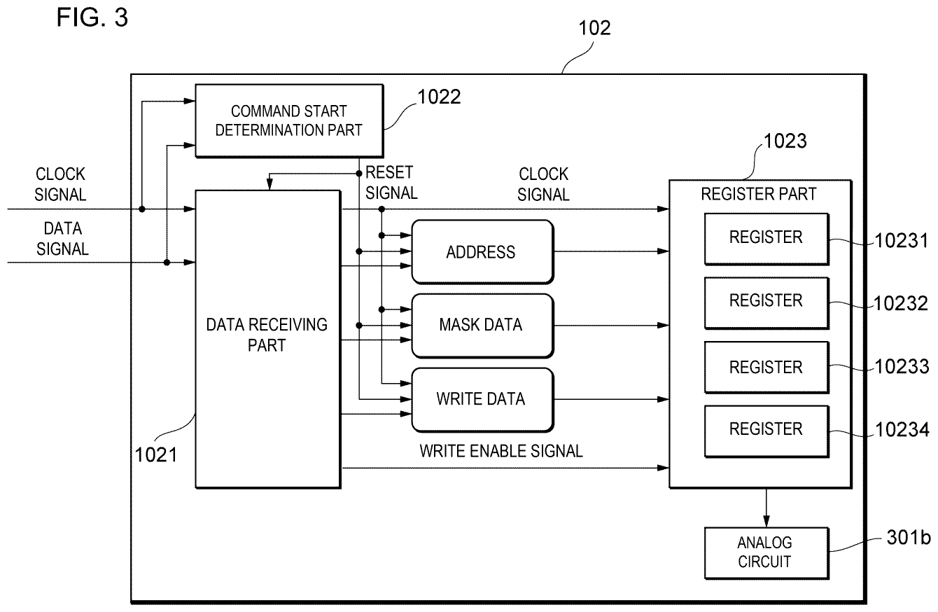

Referring to FIG. 3, the sub-device 102 is described. Note that other sub-devices, including the sub-device 103, have a similar configuration. The sub-device 102 includes a data receiving part 1021, a command start determination part 1022, and a register part 1023.

The data receiving part 1021 receives the address signal and the write data signal, which are included in the data signal.

The command start determination part 1022 determines whether a transmission of the data signal from the command interpretation device 101 to the sub-device 102 is started or not, on the basis of the clock signal and the main signal. When the supply of the data signal starts, the command start determination part 1012 transmits a reset signal to the data receiving part 1021.

The register part 1023 is a rewritable storage area including registers 10231, 10232, 10233, and 10234. Furthermore, the register part 1023 controls the writing to each register on the basis of signals from the data receiving part 1021. The registers 10231, 10232, 10233, and 10234 each have unique addresses. Furthermore, addresses of the registers of the sub-device 103 are different from or the same as those of the registers 10231, 10232, 10233, and 10234. The register part 1023 is connected to the analog circuit 301b.

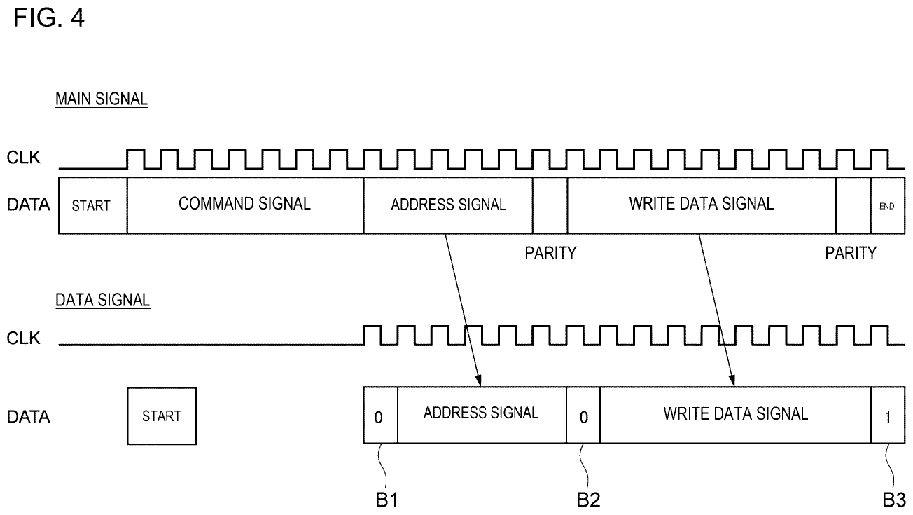

Referring to FIG. 4, examples of the data signal generation by the command interpretation device 101 and the data signal interpretation by the sub-device 102 are described. FIG. 4 illustrates examples of the main signal and the data signal in the case where the command for performing writing to at least one register in a certain device results in writing data to one register.

The main signal includes a start signal, the command signal, the address signal, the write data signal, and an end signal in this order.

When the data receiving part 1011 receives the main signal from the main device 201, the data receiving part 1011 interprets the command signal. In the case where the command signal represents the command that specifies performing of the writing to at least one register in a certain device, the data transmitting part 1015 generates information in which identification information B1 is added to the top position of the address signal on the basis of the address signal, the command identification information, and the bit location information. The identification information B1 is one-bit information and specifies that the address length is 5 bits when the bit value is 0 and that the address length is 8 bits when the bit value is 1. The data transmitting part 1015 stores the identification information B1 at the location corresponding to the first clock of the address signal of the main signal and transmits the data signal in which the address signal is shifted by one clock. Note that in this case, in the address signal of the main signal, parity bits are included at the top position and the end position, and information that specifies the actual address is stored between these parity bits. The data signal generation part 1013 writes the identification information B1 at the location of the first parity bit and writes the actual address in the following bits.

Next, subsequent to the address signal, the data signal generation part 1013 generates information in which identification information B2 is added to the top position of the write data signal. The identification information B2 is one-bit information and specifies that the content of the following signal is the write data signal when the bit value is 0, and that the content of the following signal is a mask signal designating a bit or bits at which the writing is not performed when the bit value is 1. The data transmitting part 1015 sets the identification information B2 at the data signal that corresponds to the first clock of the write data signal of the main signal and transmits the data signal in which the write data signal is shifted by one clock. Furthermore, also in the data signal, parity bits are included at the top position and the end position, and the information that specifies the actual write data is stored in bits sandwiched between these parity bits. The data signal generation part 1013 writes the identification information B2 at the location of the first parity bit of the write data signal, and further writes the actual write data signal or mask signal in the following bits.

In the example of FIG. 4, only one write data signal is included in the main signal. Thus, the data signal generation part 1013 generates the data signal in such a way that identification information B3 is added at the last parity bit of the write data signal. The identification information B3 is one-bit information and specifies that the writing to the register based on the write data is not performed when the bit value is 0. In this case, the register of the sub-device 102 is not rewritten. Furthermore, when the bit value of the identification information B3 is 1, the identification information B3 specifies that the writing to the register based on the write data is performed. The signal in which the bit of the identification information B3 is 1 functions as a write instruction signal that specifies the writing of information based on the data signal to the register of the sub-device. Note that, for example, in the case where there is an error in the write data signal, the data signal generation part 1013 sets the bit value of the identification information B3 to 0 so as not to perform the writing.

In the data communication device 10, each of sub-devices, such as the sub-device 102, the sub-device 103, and the like, receives the address signal included in the data signal received by the data receiving part 1021.

The data receiving part transmits a write enable signal to the register part 1023 on the basis of the identification information included in the data signal. The register part 1023 determines whether or not interpreted address information corresponds to the address of the register 10231 or any other register included in this register part 1023. In the case where the address information corresponds to the address of the register included in this register part 1023 and the bit value of the identification information B3 is 1, the register part 1023 writes the write data signal to the corresponding register. Even when the bit value of the identification information B3 is 1, if the interpreted address information does not correspond to the address of the register included in this register part 1023, the register part 1023 will not perform the writing to the register 10231 or the like based on the write data signal.

In this way, it becomes possible to make a conclusive determination of whether the writing should be performed or not on condition of having the matching address, which differs from register to register, even in the case where a common data signal is sent from the command interpretation device 101 to a plurality of sub-devices. This enables appropriate rewriting of the register of each sub-device.

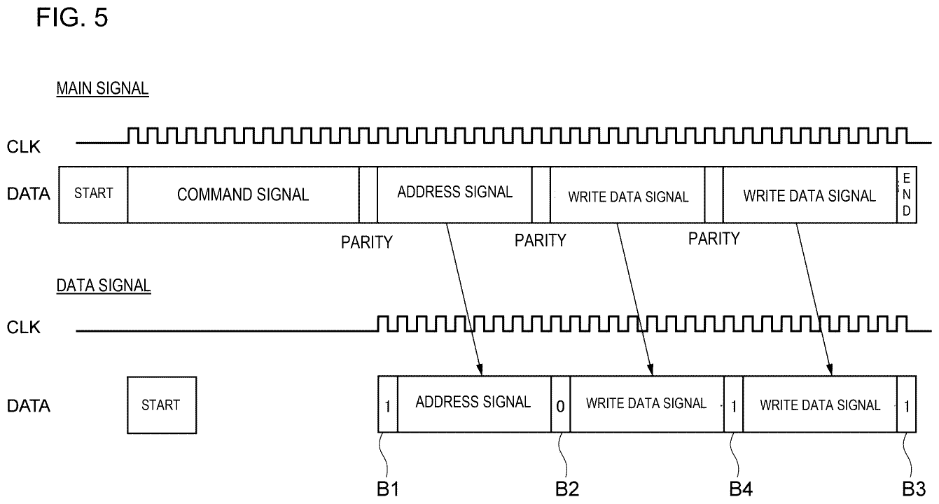

Referring to FIG. 5, other examples of the data signal generation by the command interpretation device 101 and the data signal interpretation by the sub-device 102 are described. FIG. 4 illustrates examples of the main signal and the data signal in the case where the command that specifies performing of writing to at least one register in a certain device results in writing data to two registers.

The main signal includes the start signal, the command signal, the address signal, a first write data signal, a second write data signal, and the end signal in this order.

The data transmitting part 1015 generates information in which the identification information B1, which is set to 0, is added to the top position of the address signal. Subsequent to the address signal, the data signal generation part 1013 generates information in which the identification information B2 is added to the top position of the first write data signal.

Next, subsequent to the first write data signal, the data signal generation part 1013 generates information in which identification information B4 is added to the end position of the first write data signal. In the example of FIG. 5, the identification information B4 is one-bit information and specifies that the writing to the register based on the write data is not performed when the bit value thereof is 0, as is the case with the identification information B3. Furthermore, the identification information B4 specifies that the writing to the register based on the write data is performed when the bit value thereof is 1.

Finally, the data signal generation part 1013 generates the data signal in such a way that the identification information B3 is added at the end position of the write data signal.

Even in the example of FIG. 5, the sub-device 102 interprets the address information included in the data signal received by the data receiving part 1021. Here, the example is described using the case where the address signal specifies a register included in the sub-device 102.

The data receiving part 1021 receives the identification information B2 and the first write data signal that follows the address signal. Because the bit value of the identification information B2 is 0, it is determined that the following data is the write data. Subsequently, the data receiving part 1021 receives the identification information B4 and the second write data signal that follows the first data signal. Because the bit value of the identification information B4 is 1, the data receiving part 1021 determines that the first write data may be written to the register. Finally, the data receiving part 1021 receives the identification information B3 that follows the second write data signal. Because the bit value of the identification information B3 is 1, the data receiving part 1021 determines that the second write data may be written to the register. In this case, the data receiving part 1021 increments the address specified by the first address information and writes the second write data to the following register.

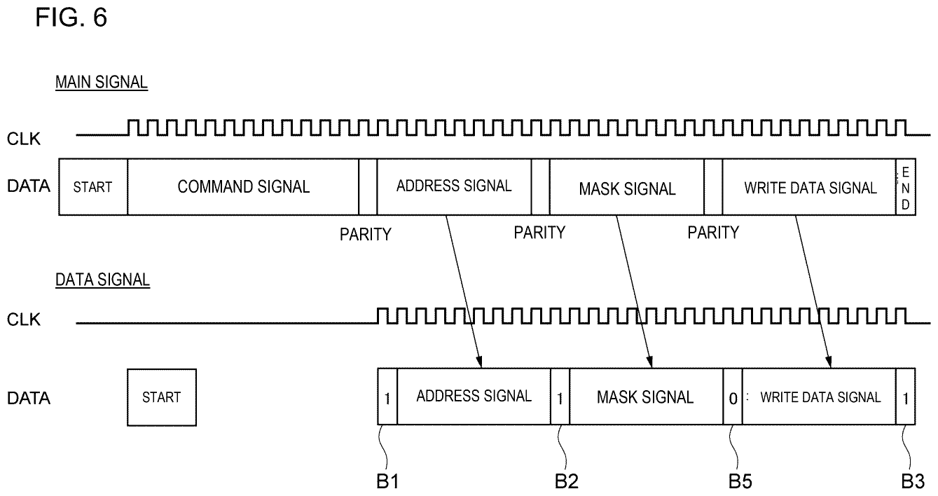

Referring to FIG. 6, other examples of the data signal generation by the command interpretation device 101 and the data signal interpretation by the sub-device 102 are described. FIG. 4 illustrates examples of the main signal and the data signal in the case where the command that specifies performing of writing to one register in a certain device while masking a bit value or bit values results in writing data to one register.

The main signal includes the start signal, the command signal, the address signal, the mask signal, the write data signal, and an end signal in this order.

The data transmitting part 1015 generates information in which the identification information B1, which is set to 0, is added to the top position of the address signal. Subsequent to the address signal, the data signal generation part 1013 generates information in which the identification information B2 is added to the top position of the first write data signal. In this case, because the command specifies performing of writing to one register in a certain device while masking a bit value or bit values, the data signal generation part 1013 sets the bit of the identification information B2 to 1.

Next, subsequent to the mask signal, the data signal generation part 1013 generates information in which identification information B5 is added to the top position of the write data signal. In the example of FIG. 5, the identification information B5 is one-bit information and specifies that the content of the following signal is the write data signal when the bit value is 0, as is the case with the identification information B2, and that the content of the following signal is the mask signal that specifies a bit or bits to be masked when the bit value is 1.

Finally, the data signal generation part 1013 generates the data signal in such a way that the identification information B3 is added at the end position of the write data signal.

Even in the example of FIG. 6, the sub-device 102 interprets the address information included in the data signal received by the data receiving part 1021.

The data receiving part 1021 receives the identification information B2 and the mask signal that follows the address signal. Because the bit value of the identification information B2 is 1, it is determined that the following signal is the mask signal. Subsequently, the data receiving part 1021 receives the identification information B5 and the write data signal that follows the mask signal. Because the bit value of the identification information B5 is 0, the data receiving part 1021 determines that the content of the signal is the write data. Finally, the data receiving part 1021 receives the identification information B3 that follows the write data signal. Because the bit value of the identification information B3 is 1, the data receiving part 1021 determines that the write data may be written to the register. In this case, the data receiving part 1021 writes the write data to the register that corresponds to the address specified by the first address information without rewriting the bit or bits specified by the mask signal.

In the examples of FIG. 4 to FIG. 6, the data signal generation part 1013 adds the identification information B3 at the end position of the data signal, and this enables the sub-device 102 to determine whether the writing should be performed or not. However, the data signal generation part 1013 does not necessarily add the identification information B3 in the data signal. For example, the data communication device 10 may allow the sub-device 102 to determine whether the writing should be performed or not by checking the presence or absence of the clock signal that the data transmitting part 1015 transmits.

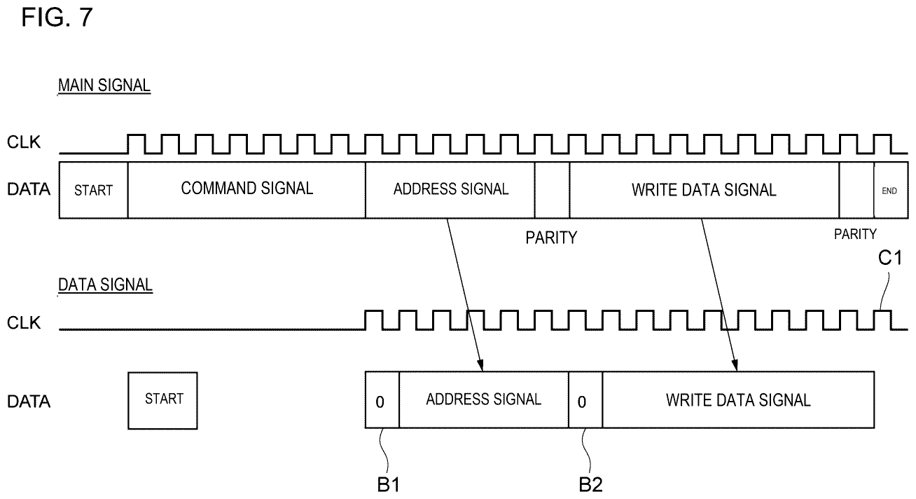

An example of this case is illustrated in FIG. 7. The main signal illustrated in the example of FIG. 7 is the same as in FIG. 4. However, the data signal generation part 1013 is different from the example in FIG. 4 in that the identification information B3 is not added at the end position of the data signal.

In the example of FIG. 7, in the case where the command interpretation device 101 allows the sub-device 102 to write data, the data transmitting part 1015 transmits a clock signal C1 to the sub-device 102 subsequent to the write data signal. When the data receiving part 1011 receives the clock signal C1 subsequent to the write data signal, the sub-device 102 determines that the writing of data can be performed. The clock signal C1 functions as the write instruction signal that specifies the writing of information based on the data signal to the register of the sub-device.

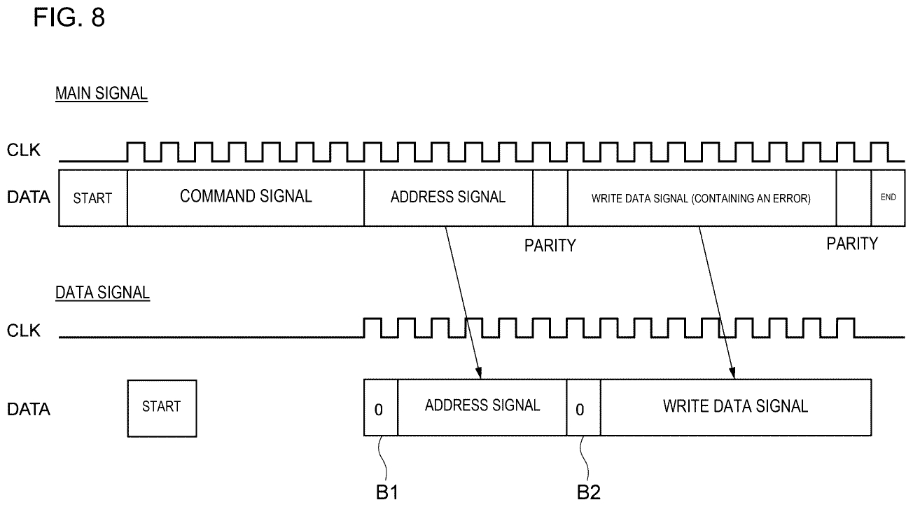

FIG. 8 illustrates an example of the case where the writing of data is not performed due to a reason such as the presence of an error in the write data signal or the like. In this case, the data transmitting part 1015 does not transmit the clock signal to the sub-device 102 subsequent to the write data signal. Because the data receiving part 1011 does not receive the clock signal subsequent to the write data signal, the sub-device 102 does not write data.

As described above, in the data communication device 10, it is determined whether or not the data writing should be performed to the sub-device 102 or the like on the basis of the clock signal or the identification information from the command interpretation device 101.

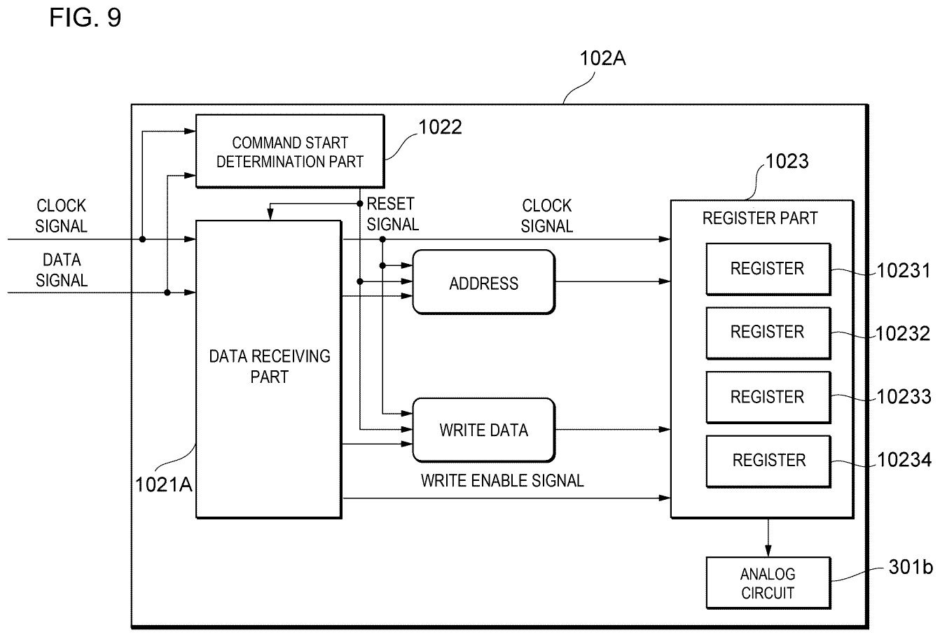

FIG. 9 illustrates another example of the configuration of the sub-device 102. A sub-device 102A that includes a data receiving part 1021A is also capable of not performing the operation that corresponds to the command that specifies performing of writing while masking a bit value or bit values.

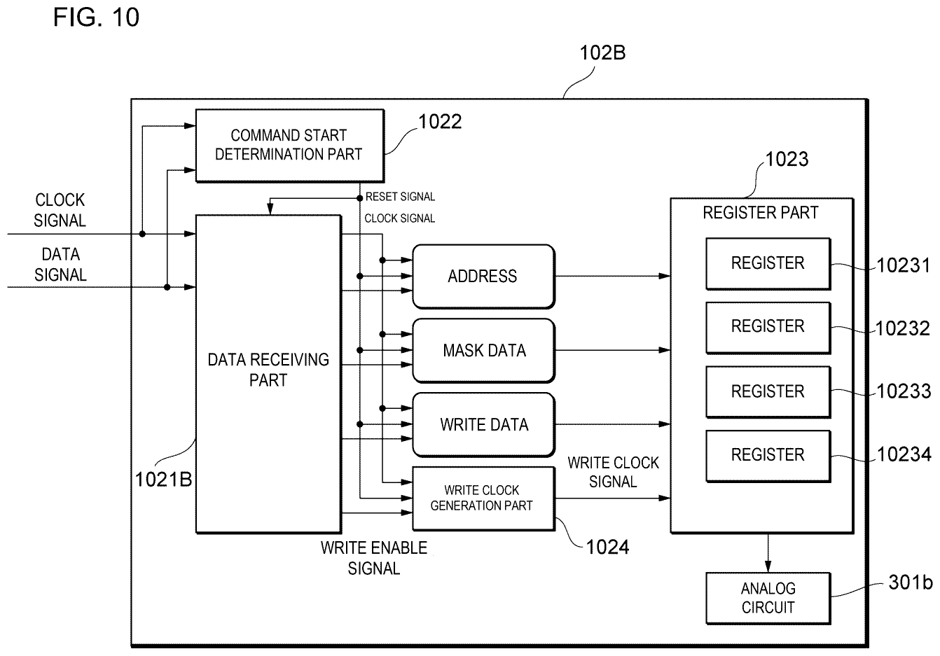

FIG. 10 illustrates another example of the configuration of the sub-device 102. A sub-device 102B that includes a data receiving part 1021B further includes a write clock generation part 1024. In the sub-device 102B, the write enable signal based on the data signal may be converted by the write clock generation part 1024, and the writing to the register part 1023 based on the clock signal may be controlled, as described in FIG. 7 and FIG. 8.

The present embodiment has been described. The data communication device 10 according to the present embodiment includes: the command interpretation device 101 that is connected to the main device 201, receives, from the main device, the main signal including the command signal, the address signal that designates the address of the register or the addresses of the registers included in the sub-device 102 and the sub-device 103, and the write data signal to be stored in the register or the registers corresponding to the address or the addresses, and interprets the command signal; and the sub-device 102 and the sub-device 103 connected to the command interpretation device via the first signal line through which the clock signal is transmitted and the second signal line through which the data signal is transmitted.

In the data communication device 10, the command interpretation device 101 generates the write instruction signal in the case where information based on the data signal is written to the sub-device 102 or the sub-device 103 on the basis of the interpretation result of the command signal, generates the data signal that is based on the address signal and the write data signal and is to be supplied to each of the at least one sub-device on the basis of the interpretation result of the command signal, and supplies, to each of the at least one sub-device, the write instruction signal via the clock signal line 104 or the data signal line 105 and the data signal via the data signal line 105, and each of the at least one sub-device determines whether the register corresponding to the address specified by the address signal is included in the at least one sub-device or not, and writes the write data signal to the register in the case where the register is included in the at least one sub-device and the write instruction signal is supplied from the command interpretation device.

In the data communication device 10, it becomes possible to provide the circuit for command interpretation, whose circuit size is large, only in the command interpretation device 101. The sub-devices 102 and 103 only need to have the circuit for address interpretation, and this enables a reduction of the circuit size in the sub-devices 102 and 103. In this way, it becomes possible to reduce the overall circuit size of the data communication device 10.

In the mode described above, the command interpretation device 101 may generate the data signal including the identification information based on the type of writing of the write data signal to at least one register, the write instruction signal may be included at the end position of the data signal as the identification information, and each of the at least one sub-device may write the write data signal to the register on the basis of the identification information.

This eliminates the need for the circuit that interprets the command in the sub-devices 102 and 103, and this enables a reduction in the circuit size of the data communication device 10. Furthermore, in the sub-devices 102 and 103, this eliminates the need for the circuit that determines whether the data should be written or not, and this enables a reduction in the circuit size of the data communication device 10.

In the mode described above, the identification information may alternatively be information that specifies the data length of the data signal. In the mode described above, the identification information may alternatively be information that specifies the kind of data included in the data signal.

In the mode described above, the types of writing may include a type of writing that specifies writing of part of the write data signal to a register without rewriting a predetermined bit or bits of the register, the identification information may specify whether the kind of data included in the data signal is the write data signal or the mask signal specifying the predetermined bit or bits that are not rewritten, and each of the at least one sub-device may write part of the write data signal to at least one register on the basis of the write data signal and the mask signal. In this way, it becomes possible to write data while masking a predetermined bit or bits.

In the mode described above, the command interpretation device 101 may generate the data signal after storing the identification information at a parity bit that follows the address signal designating the address of the at least one register.

In this way, it becomes possible to generate the data signal based on the main signal while maintaining the data width.

In the mode described above, the types of writing may include the type of writing that specifies writing of the first write data signal to the first register of the at least one sub-device and writing of the second write data signal to the second register of the at least one sub-device, the identification information may be included at the end position of each of the first write data signal and the second write data signal, each of the at least one sub-device may write the first write data signal to the first register and may write the second write data signal to the second register on the basis of the identification information. In this way, it becomes possible to write information to a plurality of registers successively. Furthermore, it becomes possible to generate the data signal based on the main signal while maintaining the data width.

In the mode described above, the write instruction signal may alternatively be the clock signal generated subsequent to the data signal. Furthermore, in the mode described above, in the case where there is an error in the main signal, the command interpretation device 101 may determine that the write data signal is not to be written to one of the at least one sub-device.

In this way, it becomes possible to eliminate the need for conducting error detection by the sub-device 102 and the like, and this enables reductions in the circuit sizes of the sub-devices 102 and 103. In this way, it becomes possible to reduce the overall circuit size of the data communication device 10.

Note that all the embodiments that have been described above are provided to facilitate understanding of the present disclosure and are not to be construed as limiting the present disclosure. The present disclosure can be modified or improved without departing from its spirit, and the present disclosure also includes equivalents thereof. That is to say, ones obtained by suitably modifying designs of the respective embodiments by those skilled in the art are also included within the scope of the present disclosure as long as they include features of the present disclosure. For example, each element included in each embodiment as well as its arrangement, condition, and the like are not limited to those exemplified, and may be suitably changed. Needless to say, each embodiment is for illustrative purposes only, and constituent elements illustrated in different embodiments may be combined or partially exchanged. Resulting embodiments are also included in the scope of the present disclosure so long as the characteristic features of the present disclosure are included.
<1> A data communication device comprising: a command interpretation device that is connected to a main device, receives, from the main device, a main signal including a command signal, an address signal that designates an address of at least one register included in the at least one sub-device, and a write data signal to be stored in the register corresponding to the address, and interprets the command signal; and at least one sub-device connected to the command interpretation device via a first signal line through which a clock signal is transmitted and a second signal line through which a data signal is transmitted, wherein the command interpretation device generates a write instruction signal in a case where information based on the data signal is written to one of the at least one sub-device on a basis of an interpretation result of the command, generates the data signal that is based on the address signal and the write data signal and is to be supplied to each of the at least one sub-device on the basis of the interpretation result of the command signal, and supplies, to each of the at least one sub-device, the write instruction signal via the first signal line or the second signal line and the data signal via the second signal line, and each of the at least one sub-device determines whether the register corresponding to the address specified by the address signal is included in the at least one sub-device or not, and writes the write data signal to the register in a case where the register is included in the at least one sub-device and the write instruction signal is supplied from the command interpretation device.
<2> The data communication device according to <1>, wherein the command interpretation device generates the data signal including identification information based on a type of writing of the write data signal to the at least one register, the write instruction signal is included at an end position of the data signal as the identification information, and each of the at least one sub-device writes the write data signal to the register on a basis of the identification information.
<3> The data communication device according to <2>, wherein the identification information is information that specifies a data length of the data signal.
<4> The data communication device according to <2>, wherein the identification information is information that specifies a kind of data included in the data signal.
<5> The data communication device according to <4>, wherein the types of writing include a type of writing that specifies writing of part of the write data signal to the register without rewriting a predetermined bit of the register, the identification information specifies whether the kind of data included in the data signal is the write data signal or a mask signal specifying the predetermined bit that is not rewritten, and on a basis of the write data signal and the mask signal, each of the at least one sub-device writes the part of the write data signal to the at least one register.
<6> The data communication device according to <5>, wherein the command interpretation device generates the data signal after storing the identification information at a parity bit that follows the address signal specifying the address of the at least one sub-device.
<7> The data communication device according to <4>, wherein the types of writing include a type of writing that specifies writing of a first write data signal to a first register of the at least one sub-device and writing of a second write data signal to a second register of the at least one sub-device, the identification information is included at an end position of each of the first write data signal and the second write data signal, and on the basis of the identification information, each of the at least one sub-device writes the first write data signal to the first register and writes the second write data signal to the second register.
<8> The data communication device according to <1>, wherein the write instruction signal is the clock signal generated subsequent to a data signal.
<9> The data communication device according to any one of <1> to <8>, wherein in a case where there is an error in the main signal, the command interpretation device determines that the write data signal is not to be written to one of the at least one sub-device.
10 data communication device
101 command interpretation device
102, 103 sub-device
104 clock signal line
105 data signal line
201 main device
301 analog circuit
1011 data receiving part
1012 command start determination part
1013 data signal generation part
1014 clock enable signal generation part
1015 data transmitting part
1021 data receiving part
1022 command start determination part
1023 register part

1. A data communication device comprising:
a command interpretation device that is connected to a main device, and that:
receives, from the main device, a main signal including a command signal, an address signal that designates an address of at least one register included in at least one sub-device, and a write data signal for storing in the register corresponding to the address, and
interprets the command signal; and
at least one sub-device connected to the command interpretation device via a first signal line through which a clock signal is transmitted, and via a second signal line through which a data signal is transmitted,
wherein the command interpretation device is configured to:
generate a write instruction signal when information based on the data signal is written to one of the at least one sub-device based on an interpretation result of the command signal,
generate the data signal that is based on the address signal and the write data signal and that is supplied to each of the at least one sub-device based on the interpretation result of the command signal, and
supply, to each of the at least one sub-device, the write instruction signal via the first signal line or via the second signal line, and supply the data signal via the second signal line, and
wherein each of the at least one sub-device is configured to:
determine whether the register corresponding to the address specified by the address signal is included in the at least one sub-device or not, and
write the write data signal to the register when the register is included in the at least one sub-device and the write instruction signal is supplied from the command interpretation device.

2. The data communication device according to claim 1,
wherein the command interpretation device is configured to generate the data signal including identification information based on a type of writing of the write data signal to the at least one register,
wherein the write instruction signal is included at an end position of the data signal as the identification information, and
wherein each of the at least one sub-device is configured to write the write data signal to the register based on the identification information.

3. The data communication device according to claim 2, wherein the identification information specifies a data length of the data signal.

4. The data communication device according to claim 2, wherein the identification information specifies a kind of data included in the data signal.

5. The data communication device according to claim 4,
wherein the types of writing include a type of writing that specifies writing of part of the write data signal to the register without rewriting a predetermined bit of the register,
wherein the identification information specifies whether the kind of data included in the data signal is the write data signal or a mask signal specifying the predetermined bit that is not rewritten, and
wherein each of the at least one sub-device is configured to write the part of the write data signal to the at least one register based on the write data signal and the mask signal.

6. The data communication device according to claim 5, wherein the command interpretation device is configured to generate the data signal after storing the identification information at a parity bit that follows the address signal designating the address of the at least one register.

7. The data communication device according to claim 4,
wherein the types of writing include a type of writing that specifies writing of a first write data signal to a first register of the at least one sub-device and writing of a second write data signal to a second register of the at least one sub-device,
wherein the identification information is included at an end position of each of the first write data signal and the second write data signal, and
wherein each of the at least one sub-device is configured to write the first write data signal to the first register and to write the second write data signal to the second register based on the identification information.

8. The data communication device according to claim 1, wherein the write instruction signal is the clock signal generated subsequent to a data signal.

9. The data communication device according to claim 1, wherein when there is an error in the main signal, the command interpretation device is configured to determine that the write data signal is not to be written to one of the at least one sub-device.
